(19) United States
(12) Patent Application Publication
(10) Pub. No.: US 2007/0000601 A1
(43) Pub. Date: Jan. 4, 2007

(54) Process and device for determing the quality of a weld seam or a thermal spray coating

(76) Inventors: Joerg Hoeschele, Meckenbeuren-Brochenzell (DE); Alexander Ohnesorge, Immenstaad (DE); Juergen Steinwandel, Uhldingen-Muehlhofen (DE)

Correspondence Address: AKERMAN SENTERFITT, P.O. BOX 3188, WEST PALM BEACH, FL, 33402-3188, US

(21) Appl. No.: 11/174,031

(22) Filed: Jul. 1, 2005

(51) Int. Cl. B32B 37/00

(52) U.S. Cl. 156/272.2

(57) ABSTRACT

Process and device for determining the quality of a weld seam or a thermal spray coating. In application processes such as welding the actual number of the process and material parameters determine a large range of resulting characteristics of the applied material. The task of the present invention is comprised of providing a process and a device for determining the quality of specific layer characteristics, in particular their adhesion or strength of joining to the base material. This task is solved thereby, that as the quality characteristic there is employed the degree of mixing of the applied material with the base material.

### BACKGROUND OF THE INVENTION

1. Field of the invention

The invention concerns a process for determining the quality of a weld seam or a thermal spray coating layer according to the precharacterizing portion of Patent Claim 1 as well as a corresponding device according to the precharacterizing portion of Patent Claim 7 as well as their use. A process of this generic type is already known from DE 43 13 287 A1 or from DE 33 44 683 A1.

2. Related Art of the Invention

In an application or depositing processes such as welding (in particular laser application welding) or thermal spraying the large number of processes and material parameters dictate a large range of deviations of the resulting characteristics of the applied material. Known processes for quality determination include X-ray or eddy current checking, by means of which defects such as pores or inclusions can be determined. As further quality criteria in accordance to DE 43 13 287 A1 the depth of the welded is determined by spectral analysis of two ion lines of a characteristic element. An Echelle-spectrometer is disclosed in DE 199 00 308 A1. The production of surface plasma and the spectral analysis thereof is known from DE 43 41 462 A1 or DE 37 18 672 A1.

These processes are however only limitedly suited to quality determination of specific layer characteristics, in particular the adhesion to the base material.

### SUMMARY OF THE INVENTION

It is thus the task of the present invention to provide a process and a device for determining the quality of specific layer characteristics, in particular their adhesion to the base material, as well as the use thereof.

With regard to the process and the device for quality determination as well as the employment thereof the invention is set forth in Patent Claims 1, 5 and 7. Further claims contain advantageous embodiments and further developments.

With regard to the process to be provided, the task is solved in that, as the quality characteristic, the degree of mixture of the applied material with the base material is employed. The degree of mixing is a measure for the mixing-through of the applied material with a base material. Advantageous processes for determining the degree of mixing are set forth in the dependent claims.

The degree of mixing is, in comparison to the depth of welding, a substantially better criteria for determining layer characteristics, in particular their chemical characteristics and adhesion to the base material. In accordance with the invention this concerns basically a homogenous degree of mixing over the cross section of the applied material. Research under real conditions has shown that this assumption has been broadly justified. In-homogeneities of the mixing-through are of relevance or noticeable only in the case of exotic material combinations and extreme requirements of exactness. However, even in these cases, empirical correlations between the surface signals, the gradient of the degree of mixing, and quality characteristics can be determined, so that the inventive process can continue to be employed.

The degree of mixing can be determined by analysis of the radiation/illumination given off during the process or also by a specially produced plasma, on the surface of the applied material.

In an advantageous embodiment of the inventive process the determination of the degree of mixing occurs by spectral analysis, preferably at least two spectral lines, of the radiation emitted from the location being examined. For this, by means of the spectral analysis, characteristic parameters of at least respectively one characteristic spectral line of the base material and another characteristic spectral line of the applied material are assigned a specific degree of mixing. The correlation equation is preferably stored in a computer and thus easily accessible. The correlation equation can be determined, by using exemplary layers, for example welding seams, for typical material systems, by adjustment or calibration or verification/comparison with known measurement values (EDX=energy dispersive x-ray radiation, x-ray-fluorescence . . . ).

Preferably the spectral analysis occurs using an Echelle-spectrometer. Echelle-spectrometers achieve a very high resolution in large spectral regions. Echelle-spectrometers are available are suitable for the most important spectral regions, and in particular in the visible, UV-, and IR-region.

One Echelle-spectrometer produces many spectra with high correlation numbers, which in part overlap. By means of a supplemental prism in the beam path the overlapping can be joined perpendicular to the direction of spreading of the Echelle-spectrometer, so that a two-dimensional image of spectral correlation results, which are provided superimposed or above each other in the exit side of the spectrometer. This image can be recorded by an electronic camera in the appropriate spectral region, of which the plurality of photosensitive individual sensors (preferably multiple mega-pixel) can then make possible the simultaneous detection of multiple thousand spectral lines.

In a further advantageous embodiment of the inventive process the radiation to be analyzed is emitted from a surface plasma, which is induced by a short (few nanoseconds) energy impulse. The energy impulse can be transmitted in various modes and manners, for example by laser radiation or microwaves or by means of discharge arc or spark (arc or spark emission). Therein, the material layer to be examined can be vaporized in a small area by sudden introduction of energy and be electronically excited, and thus a characteristic surface plasma can be induced. This type of plasma shows a typical “bremsstrahlung” (decelerated radiation) and recombination continuum. In order to effectively suppress this and be able to analyze the characteristic line spectra, the spectral analysis is set to occur after the introduction of energy, preferably with a delay of 50 to 300 ns, in particular 80 to 150 ns. This time delay ensures a reliable allocation or classification or correlation or mapping of the individual spectral lines, in particular in the higher Echelle orders (higher order harmonics).

The synchronization of energy input, for example laser pulse, and measurement with the spectrometer, can occur using conventional PC-control maps and trigger generators.

A further improvement in the precision of the measurement results can be accomplished by time correlated measurement of the decay or dying out behavior. For this, an image amplifier is preferably employed, in particular a residual light image amplifier, in order to insure sufficient light intensity even in the case of small time separation, that is, high recording frequency.

In a further advantageous embodiment of the inventive process specific spectral lines are selected depending upon the base and applied material and supplied to the analysis, which are preferably already kept available in a data bank. The other detected spectral regions are discarded or disregarded and not analyzed. Thereby the analysis of the relevant spectrum is substantially accelerated, whereby a good online ability of the process results.

The task with regard to the device to be provided is inventively solved in that it includes an Echelle-spectrometer, as well as a computer associated therewith, in which a first allocation or classification or mapping between characteristic spectral parameters and the degree of mixing of the applied material with the base material, and a second correlation between the degree of mixing and a quality scale, is stored.

In a particular advantageous embodiment the device further includes a device for production of a surface plasma, preferably a short pulse laser.

The inventive process and the inventive device are particularly suited for application in the motor vehicle industry, in particular in the production of land or air vehicles or their parts.

In the following the inventive process and the inventive device are described in greater detail on the basis of an illustrative embodiment:

Therein the device includes an Echelle-spectrometer and a device for production of a short laser pulse, as well as a therewith associated computer, in which a first correlation between characteristic spectral parameters and the degree of mixing of the applied material with the base material, and a second correlation between the degree of mixing and a quality scale, is stored.

The Echelle-spectrometer includes an Echelle-gate for production of multiple spectrum (in the visible spectral region) with high order numbers, which in part overlap, as well as a supplemental prism, which is positioned in the beam path in such a manner that the overlaps join perpendicular to the degree of spreading of the Echelle-gate, so that a two-dimensional image of spectral arrangements or orders or regimes or organizations results, which are provided or associated on the emission plane of the spectrometer.

This image is recorded by an electronic camera in appropriate optical spectral regions, of which the large number of photosensitive individual sensors (8 mega-pixel) can then enable the simultaneous detection of multiple thousand of spectral lines.

The computer includes a control map and a trigger generator with which the vice for production of a short laser pulse and the electronic camera for recording the two-dimensional Echelle-spectra can be controlled and be synchronized with a time delay or offset of 100 ns. The time separation ensures the suppression of the typical bremsstrahlung and recombination continuum and ensures a reliable correlation of the individual spectral lines, in particular in the higher Echelle-orders.

In the computer a correlation equation between characteristic spectral parameters and the degree of mixing of the applied materials with the base material is stored and thereby easily accessible. The correlation equation is determined using exemplary layers—here using applied weld seams—for typical material systems, here: application of Stellite (Co-based alloy)—powder on ST37-steel samples by calibration/gauging/verification/comparison with known measurement processes (analytic energy dispersive X-ray radiation (EDX), X-ray-fluorescents-analysis, . . . ). Characteristic spectral parameters are produced here in particular in the Fe (I)- and Co (I)-lines, as well as the spectral lines 297.33 nm and 355.54 nm.

It is basically these relevant lines of the detected spectral regions that are supplied to the analysis, which thus occurs very rapidly (thus online-able) and at the same time very precisely.

The correlation equation between the degree of mixing and the quality scale with regard to the bonding behavior of the applied layer upon the base material as well as their chemical and mechanical characteristics are empirically determined by exemplary layers.

The inventive process and the inventive device have demonstrated themselves in the embodiment of the above described example as particularly suited for the quality determination of applied welding seams in the automobile and airplane industry (for example turbine blades).

In particular, thus, a significant improvement in substrate bonding and a defined mixing-through can be achieved, whereby the mechanical and chemical characteristics of the weld seam can be significantly improved.

The invention is not limited to the above described illustrative embodiment, but rather can be broadly applied.

For example, the inventive process and the inventive device can be employed online during an ongoing welding process, and the degree of mixing of the welding seam or bead can be determined. This makes possible the follow-up control and optimizing of the welding seam during the process.

Further, the process is not limited to laser welding, but rather can be applied to any application process or energy supply, for example plasma or electron beam welding.

1. A process for determining the quality of a weld seam or a thermal spray coated layer, wherein the degree of mixing of the applied material with the base is employed as the quality characteristic, the process comprising:
inducing surface plasma by an energy impulse,
determining the degree of mixing by spectral analysis, using an Echelle-spectrometer, of the surface plasma emitted radiation induced by the energy impulse,
wherein there is a time delay between the energy impulse and the spectral analysis.

2. The process according to claim 1, wherein the spectral analysis occurs by means of two spectral regions of the radiation emitted from the location to be examined.

3. The process according to claim 1, wherein the spectral analysis occurs 50 to 300 ns, in particular 80 to 150 ns, subsequent to the impulse.

4. The process according to claim 1, wherein depending upon base and applied material specific spectral regions, which are preferably provided to be available in a data bank, are selected and the analysis is carried out.

5. A device for determining of the quality of a weld seam or a thermal spray coat, with
an Echelle-spectrometer
a therewith connected computer, in which there is stored
a first correlation between spectral parameters and the degree of mixing of the applied material with the base material and
a second correlation between the degree of mixing and a quality scale,
a device for production of a surface plasma, and
a device for adjusting a time offset or delay between the production of the surface plasma and the spectral analysis by means of the Echelle-spectrometer.

6. The device according to claim 5, wherein the device for production of a surface plasma is a short pulsed laser.

7. The process as in claim 1, wherein said weld seam or a thermal spray coated layer is applied to land or air vehicles or their parts.
